(19) United States
(12) Patent Application Publication
(10) Pub. No.: US 2023/0038902 A1
(43) Pub. Date: Feb. 9, 2023

(54) INFORMATION PROCESSING DEVICE, CONTROL METHOD, AND STORAGE MEDIUM

(71) Applicant: NEC Corporation, Minato-ku, Tokyo (JP)

(72) Inventors: Naoki YOSHINAGA, Tokyo (JP); Yuzuru TATEYAMA, Tokyo (JP)

(73) Assignee: NEC Corporation, Minato-ku, Tokyo (JP)

(21) Appl. No.: 17/790,550

(22) PCT Filed: Jan. 9, 2020
(86) PCT No.: PCT/JP2020/000440

§ 371 Date: Jul. 1, 2022

(51) Int. Cl. G06Q 10/00; G05B 23/02

(52) U.S. Cl. CPC G06Q 10/20; G05B 23/0213; G05B 2223/02

(57) ABSTRACT

The information processing device includes a matching unit 32A and a display control unit 33A. The matching unit 32A is configured to match a database 21A, which associates first detection data indicative of a past state of maintenance target equipment 3 with first maintenance information relating to maintenance of the maintenance target equipment 3 in the past state, with second detection data indicative of a current state of the maintenance target equipment 3. The display control unit 33A is configured to display, based on a result of the matching by the matching unit 32A, second maintenance information relating to maintenance in accordance with the current state of the maintenance target equipment 3 on a display unit 45A.

### TECHNICAL FIELD

The present invention relates to an information processing device, a control method, and a storage medium for controlling a display relating to preventive maintenance of equipment.

### BACKGROUND ART

In general, the proper timing of equipment maintenance depends on external factors such as equipment operating conditions and weather, and varies with each equipment. In contrast, Patent Literature 1 discloses a preventive maintenance device configured to calculate the degree of abnormality that is a difference between the predicted value of the detected value obtained by a model of the normal state and the current detected value. Further, Patent Literature 1 discloses a preventive maintenance support system configured to calculate the duration until equipment fails by predicting the transition of the sensor values.

### Citation List

### Patent Literature

Patent Literature 1: JP 2017-153208A

Patent Literature 2: JP 2017-120532A

### SUMMARY

### Problem to Be Solved

Regarding such a preventive maintenance device described in Patent Literature 1, after calculating the abnormal value that is the difference between the predicted value of the detected value obtained by a model of the normal state and the current detected value, a deep domain knowledge is required to measure the timing of the maintenance. Further, the equipment targeted by the preventive maintenance support system described in Patent Literature 2 is limited to such specific equipment that the transition of the sensor value can be predictable, unfortunately, Patent Literature 2 cannot be applied to such equipment that the transition of the sensor value is unpredictable.

In view of the above-described issue, it is therefore an example object of the present disclosure to provide an information processing device, a control method, and a storage medium capable of suitably presenting information relating to the maintenance of maintenance target equipment.

### Means for Solving the Problem

In one mode of the information processing device, there is provided an information processing device including: a matching unit configured to match a database, which associates first detection data indicative of a past state of maintenance target equipment with first maintenance information relating to maintenance of the maintenance target equipment in the past state, with second detection data indicative of a current state of the maintenance target equipment; and a display control unit configured to display, based on a result of the matching, second maintenance information relating to maintenance in accordance with the current state of the maintenance target equipment on a display unit.

In one mode of the control method, there is provided a control method executed by an information processing device, the control method including: matching a database, which associates first detection data indicative of a past state of maintenance target equipment with first maintenance information relating to maintenance of the maintenance target equipment in the past state, with second detection data indicative of a current state of the maintenance target equipment; and displaying, based on a result of the matching, second maintenance information relating to maintenance in accordance with the current state of the maintenance target equipment on a display unit.

In one mode of the storage medium, there is provided a storage medium storing a program executed by a computer, the program causing the computer to function as: a matching unit configured to match a database, which associates first detection data indicative of a past state of maintenance target equipment with first maintenance information relating to maintenance of the maintenance target equipment in the past state, with second detection data indicative of a current state of the maintenance target equipment; and a display control unit configured to display, based on a result of the matching, second maintenance information relating to maintenance in accordance with the current state of the maintenance target equipment on a display unit.

### Effect

An example advantage according to the present invention is to suitably present information relating to the maintenance of maintenance target equipment.

### BRIEF DESCRIPTION OF THE DRAWINGS

FIG. 1 illustrates the configuration of the preventive maintenance support system according to a first example embodiment.

FIG. 2A illustrates an example of a block configuration of an information processing device.

FIG. 2B illustrates an example of a block configuration of a display device.

FIG. 3 illustrates an example of a functional block of the processor of the information processing device.

FIG. 4 illustrates the schematic configuration of a past data generation device.

FIG. 5A is a first specific example of the data structure of past data DB (Data Base).

FIG. 5B is a second specific example of the data structure of the past data DB.

FIG. 6A is a third specific example of the data structure of the past data DB.

FIG. 6B is a fourth specific example of the data structure of the past data DB.

FIG. 7 illustrates a list of the matching results.

FIG. 8 is a first display example of the preventive maintenance support view.

FIG. 9 is a second display example of the preventive maintenance support view.

FIG. 10 is a second display example of the preventive maintenance support view after the operation of a selection field.

FIG. 11 is a third display example of the preventive maintenance support view.

FIG. 12 is a fourth display example of the preventive maintenance support view.

FIG. 13 is a fifth display example of the preventive maintenance support view.

FIG. 14 is a sixth display example of the preventive maintenance support view.

FIG. 15 is a sixth display example of the preventive maintenance support view displaying the attention information.

FIG. 16 is an example of a flowchart showing a procedure relating to a display process performed by the information processing device.

FIG. 17 is a schematic configuration diagram of a preventive maintenance support system in a second example embodiment.

FIG. 18 is a schematic configuration diagram of an information processing device according to a third example embodiment.

### EXAMPLE EMBODIMENTS

Hereinafter, an example embodiment of an information processing device, a control method, and a storage medium will be described with reference to the drawings.

### First Example Embodiment

### System Configuration

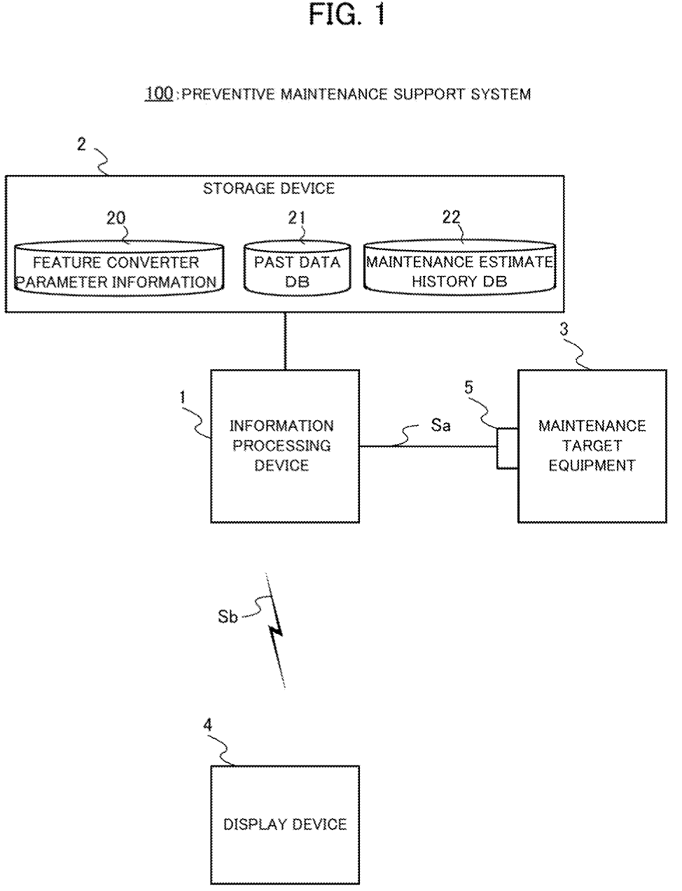

FIG. 1 shows a configuration of a preventive maintenance support system 100 according to the first example embodiment. The preventive maintenance support system 100 supports the preventive maintenance of maintenance target equipment 3 which needs maintenance such as replacement of parts and repair at periodic or irregular timing and the preventive maintenance support system 100 includes an information processing device 1, a storage device 2, the maintenance target equipment 3, a display device 4, and a state detection sensor 5.

The information processing device 1 refers to information stored in the storage device 2, and analyses a detection signal “Sa” indicating the current state of the maintenance target equipment 3 supplied from the state detection sensor 5 to thereby generate a display signal “Sb”. Then, the information processing device 1 transmits the display signal Sb to the display device 4 to thereby display a view (also referred to as “preventive maintenance support view”) showing information relating to preventive maintenance of the maintenance target equipment 3 on the display device 4.

The storage device 2 stores various information necessary for the information processing device 1 to generate the display signal Sb. The storage device 2 stores feature converter parameter information 20, a past data DB 21, and a maintenance estimate history DB 22.

The feature converter parameter information 20 stores parameters necessary for configuring a feature converter which generates feature data indicating feature values from the detection signal Sa which is time series data. The feature converter is a learning model learned to output feature data indicating the feature values of the time series data when the detection signal Sa, which is time series data, is inputted thereto. The learning model used for learning the feature converter may be a learning model based on a neural network, or it may be another type of learning model, such as a support vector machine, or it may be a combination of them. For example, if the learning model described above is a neural network such as a convolutional neural network, the feature converter parameter information 20 stores various parameters such as a layer structure, a neuron structure of each layer, the number of filters and filter sizes in each layer, and the weights of each element of each filter. Details of the feature converter will be described later.

The past data DB 21 is a database of past data indicating the past status of the maintenance target equipment 3 at multiple time points. This past data is combinations of feature data (also referred to as “first feature data Df1”) indicating the feature values of the detection signal Sa indicating a past state of the maintenance target equipment 3 and information (also referred to as “first maintenance information Im1”) relating to the maintenance of the maintenance target equipment 3 in the past state. The first maintenance information Im1 includes information on the deterioration status of the maintenance target equipment 3 in the past state, and information indicating the timing of the next maintenance of the maintenance target equipment 3 in the past state. Specific examples of the past data will be described later. The maintenance estimate history DB 22 is a database that stores the history of the estimation result regarding the maintenance estimated when the information processing device 1 generates the display signal Sb.

The storage device 2 may be an external storage device such as a hard disk connected to or built in to the information processing device 1, or may be a storage medium such as a flash memory that is detachable from the information processing device 1. The storage device 2 may include one or more server devices that perform data communication with the information processing device 1. The database stored in the storage device 2 may be distributed and stored by a plurality of devices or storage media.

The display device 4 is a terminal used by the user who manages the preventive maintenance of the maintenance target equipment 3. For example, by sending a display request specifying the device ID of the maintenance target equipment 3 to the information processing device 1, the display device 4 receives the display signal Sb that is the response result from the information processing device 1, and displays information based on the display signal Sb. As will be described later, the display device 4 displays the preventive maintenance support view based on the display signal Sb.

The state detection sensor 5 is one or more sensors for detecting the state of the maintenance target equipment 3, and transmits the detection signal Sa indicating the state of the maintenance target equipment 3 to the information processing device 1. The detection signal Sa is one or more time-series physical quantities (e.g., voltage, current, speed, force, torque, vibration amount) necessary for abnormality detection of the maintenance target equipment 3. The types of the physical quantities to be detected and the state detection sensor 5 to be used are different depending on the type of the maintenance target equipment 3. The state detection sensor 5 transmits the detection signal Sa to the information processing device 1 by wired communication or wireless communication.

The information processing device 1 may be configured by a plurality of devices. In this case, a plurality of devices constituting the information processing device 1 exchange information for executing the pre-allocated processing among the plurality of devices.

### Block Configuration

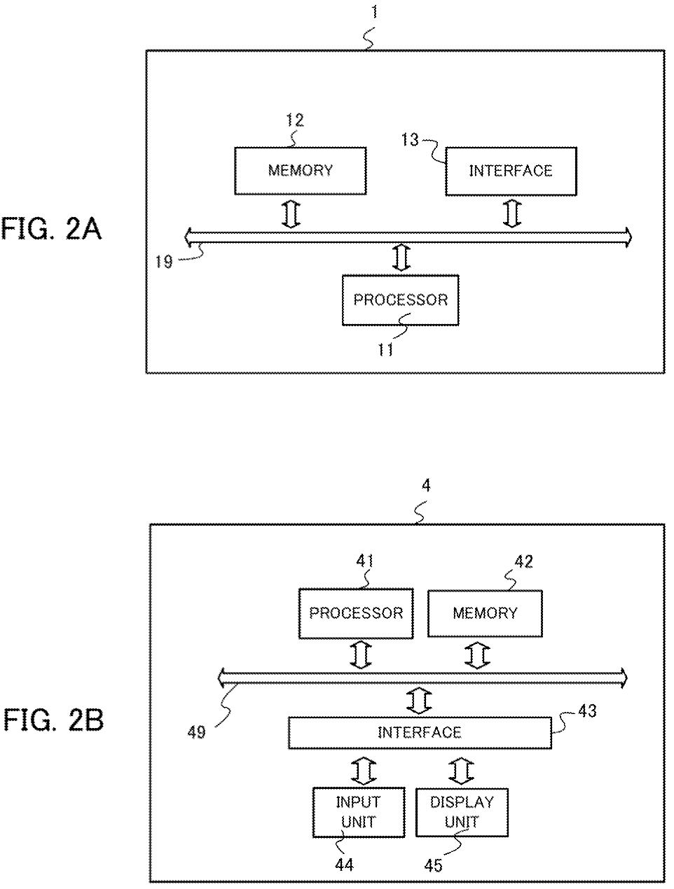

FIG. 2A shows an example of a block configuration of the information processing device 1. The information processing device 1 includes hardware that are a processor 11, a memory 12, and an interface 13. The processor 11, the memory 12, and the communication unit 13 are connected via a data bus 19.

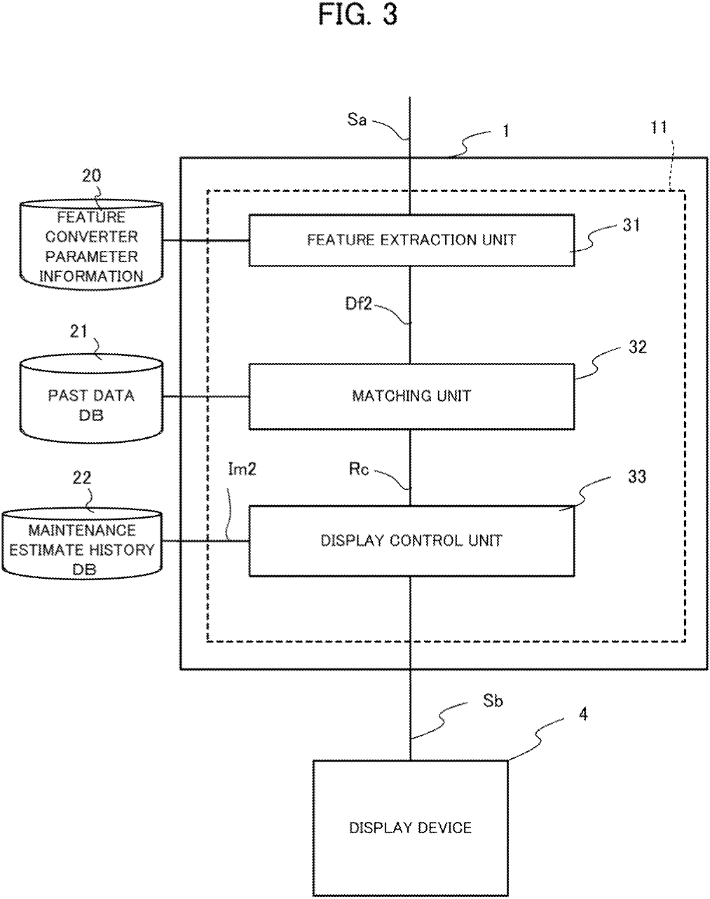

The processor 11 executes a predetermined process by executing a program stored in the memory 12. The processor 11 is one or more processors such as a CPU (Central Processing Unit) and a GPU (Graphics Processing Unit). The process executed by the processor 11 will be described in detail with reference to the functional block diagram in FIG. 3.

The memory 12 is configured by various memories such as a RAM (Random Access Memory), a ROM (Read Only Memory), and a nonvolatile memory. In addition, a program for the information processing device 1 to execute a predetermined process is stored in the memory 12. The memory 12 is used as a work memory and temporarily stores information acquired from the storage device 2. The memory 12 may function as a storage device 2. Similarly, the storage device 2 may function as a memory 12 of the information processing device 1. The program executed by the information processing device 1 may be stored in a storage medium other than the memory 12.

The interface 13 is a communication interface for transmitting and receiving data to and from an external device such as the maintenance target equipment 3 and the display device 4 by wired or wireless based on the control by the processor 11, and examples of the interface 13 include a network adapter. The external device may be connected by a cable or the like. In this case, the interface 13 may be a communication interface for performing data communication with the storage device 2, or may be an interface which confirms to a USB or a SATA (Serial AT Attachment) for exchanging data with the storage device 2.

The configuration of the information processing device 1 is not limited to the configuration shown in FIG. 2A. For example, the information processing device 1 may be connected to or incorporate at least one of an input unit for receiving an input by a user, a display unit such as a display, or a sound output device such as a speaker. For example, the information processing device 1 may be a tablet terminal or the like in which the input function and the output function are integrated with the main body.

FIG. 2B shows an example of a block configuration of the display device 4. The display device 4 includes hardware that are a processor 41, a memory 42, and an interface 43. Each element of these display devices 4 is connected via a data bus 49.

The processor 41 executes a predetermined process by executing a program stored in the memory 42. The processor 41 is one or more processors such as a CPU and a GPU. Memory 42 is configured by various memories such as a RAM, a ROM, and a non-volatile memory. Further, the memory 42 stores a program for the display device 4 to execute a predetermined process. The memory 42 is also used as a working memory.

The interface 43 is a communication interface for transmitting and receiving data to and from an external device such as the information processing device 1 by wired or wireless based on the control by the processor 41, and examples of the interface 43 include a network adapter. The external device may be connected by a cable or the like. The interface 43 performs the interface operation of the input unit 44 and the display unit 45. Examples of the input unit 44 include a button, a switch, a touch panel, and a voice input device. Examples of the display unit 45 include a display and a projector. The input unit 44 and/or the display unit 45 may be an external device electrically connecting to the display device 4 via the interface 43. The interface 43 may perform the interface operation of any device other than the input unit 44 and the display unit 45.

### Functional Block

FIG. 3 is an example of a functional block of the processor 11 of the information processing device 1. The processor 11 of the information processing device 1 functionally includes a feature extraction unit 31, a matching unit 32, and a display control unit 33.

The feature extraction unit 31 acquires the detection signal Sa indicating the current state of the maintenance target equipment 3 from the state detection sensor 5 via the interface 13. Then, the feature extraction unit 31 configures the feature converter by referring to the feature converter parameter information 20 and then extracts the feature values from the acquired detection signal Sa, and supplies data (also referred to as “second feature data Df2”) indicating the extracted feature values to the matching unit 32. In this case, for example, the feature extraction unit 31 generates the second feature data Df2 by dividing the detected signal Sa into units of segment that has a predetermined data length and inputting each divided segment to the feature converter. Here, when the state detection sensor 5 is configured by a plurality of sensors, a segment is time series data of physical quantities detected in a common time slot by the state detection sensor 5. Further, the second feature data Df2 is required to have a data amount sufficiently smaller than the data amount of a segment subject to the feature extraction process, and is, for example, a binary string with several hundred bits.

Here, if the maintenance target equipment 3 is equipment that operates continuously, the second feature data Df2 is generated for each segment of the detection signal Sa to be detected at predetermined time intervals. The time interval described above may be every one day and may be a time interval shorter than the segment length. In the latter case, each segment is determined by applying a moving window (division with overlap), which allows overlap, to the detection signal Sa. Further, when the maintenance target equipment 3 is equipment (e.g., point-switch) to operate as required, the second feature data Df2 is generated with respect to each segment of the detected signal Sa detected when the maintenance target equipment 3 is in operation. Further, when the maintenance target equipment 3 is equipment having a plurality of operating states such as a high-load operating state and a normal operating state, the second feature data Df2 is generated for each segment of the detected signal Sa detected when the equipment is in a predetermined operating state. Since the extraction timing of the detection signal Sa and the physical quantities to be referred to in the abnormality detection (i.e., determination of necessity of maintenance) are different depending on the type of the maintenance target equipment 3, their detailed description will be omitted here.

The matching unit 32 matches the past data DB21 with the second feature data Df2 supplied from the feature extraction unit 31, and supplies the matching result “Rc” to the display control unit 33. Here, the past data DB 21 is a database of the past data in which the first feature data Df1 corresponding to states of the maintenance target equipment 3 at different time points in the past is associated with the first maintenance information Im1. Accordingly, the matching unit 32 calculates the degree of similarity between the second feature data Df2 and each record of the first feature data Df1 registered in the past data DB 21, and outputs the matching result Rc indicating: the first maintenance information Im1 corresponding to a predetermined number of the first feature data Df1 in descending order according to the degree of the similarity; and their degrees of the similarity. Thus, the matching result Rc is information relating to past data indicating the past state of the maintenance target equipment 3 similar to the current state of the maintenance target equipment 3. In the present example embodiment, the matching unit 32 calculates, as an index of the described above similarity, the distance in the feature space between the feature vector indicated by the first feature data Df1 and the feature vector indicated by the second feature data Df2.

Based on the matching result Rc supplied from the matching unit 32, the display control unit 33 generates information (also referred to as “second maintenance information Im2”) relating to maintenance according to the present state of the maintenance target equipment 3. Then, the display control unit 33 transmits the display signal Sb based on the generated second maintenance information Im2 to the display device 4 via the interface 13. Here, the second maintenance information Im2 includes information on the deterioration status of the current state of the maintenance target equipment 3 with reference to the last (previous) maintenance. In some embodiments, the second maintenance information Im2 further includes information indicating the timing of the next maintenance of the maintenance target equipment 3. Specific examples of the second maintenance information Im2 generated by the display control unit 33 will be described later. The display control unit 33 stores the generated second maintenance information Im2 in the maintenance estimate history DB 22 in association with the present date (or date and time).

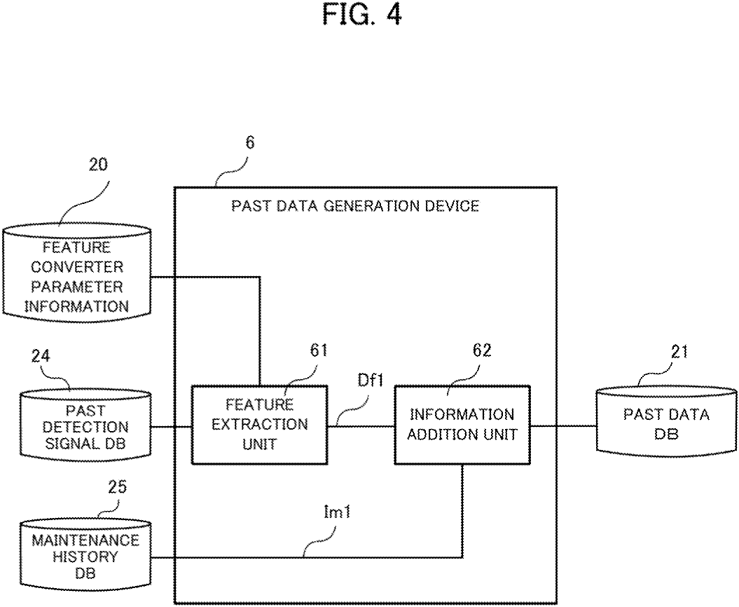

Each component of the feature extraction unit 31, the matching unit 32, and the display control unit 33 described in FIG. 4 can be realized, for example, by the processor 11 executing the program. More specifically, each component can be realized by the processor 11 executing the program stored in the memory 2. In addition, the necessary programs may be recorded in any nonvolatile recording medium and installed as necessary to realize each component. Each of these components is not limited to being implemented by software using a program, and may be implemented by any combination of hardware, firmware, and software. Each of these components may also be implemented using user programmable integrated circuitry, such as, for example, FPGA (Field-Programmable Gate Array) or a microcomputer. In this case, the integrated circuit may be used to realize a program functioning as each of the above-described components. Thus, each component may be implemented in hardware other than a processor. The above is the same in other example embodiments to be described later.

### Past Data DB

Next, a description will be supplementarily given of the generation of the past data DB 21 which is a process executed in advance by the preventive maintenance support system 100 and the data structure of the past data DB 21.

FIG. 4 shows a schematic configuration of a past data generation device 6 configured to generate the past data DB 21. The past data generation device 6 may be an information processing device 1, or may be any device other than the information processing device 1 (e.g., a personal computer or the like). In the previous stage of the service provision by the preventive maintenance support system 100, the past data generation device 6 performs the generation process of the past data DB 21 by referring to the past detected signal DB 24 and the maintenance history DB 25.

The past detected signal DB 24 is a database of the detected signal Sa which the state detection sensor 5 detected from the maintenance target equipment 3 in the past. For example, the past detection signal DB 24 includes detection signals Sa generated during previous maintenance or inspection of the maintenance target equipment 3. In some embodiments, the detection signal Sa stored in the past detection signal DB 24 may be used as training data of the feature converter in which the parameters after the learning are stored in the feature converter parameter information 20. The maintenance history DB 25 is a database in which the first maintenance information Im1 corresponding to the detection signals Sa recorded in the past detection signal DB 24 is recorded.

The past data generation device 6 functionally includes a feature extraction unit 61 and an information addition unit 62. The feature extraction unit 61 configures a feature converter based on the feature converter parameter information 20, and inputs the detected signal Sa of the past detection signal DB 24 to the feature converter, thereby generating the first feature data Df1. The information addition unit 62 registers, in the past data DB 21 as the past data, data in which the first feature data Df1 generated by the feature extraction unit 61 is associated with the corresponding first maintenance information Im1.

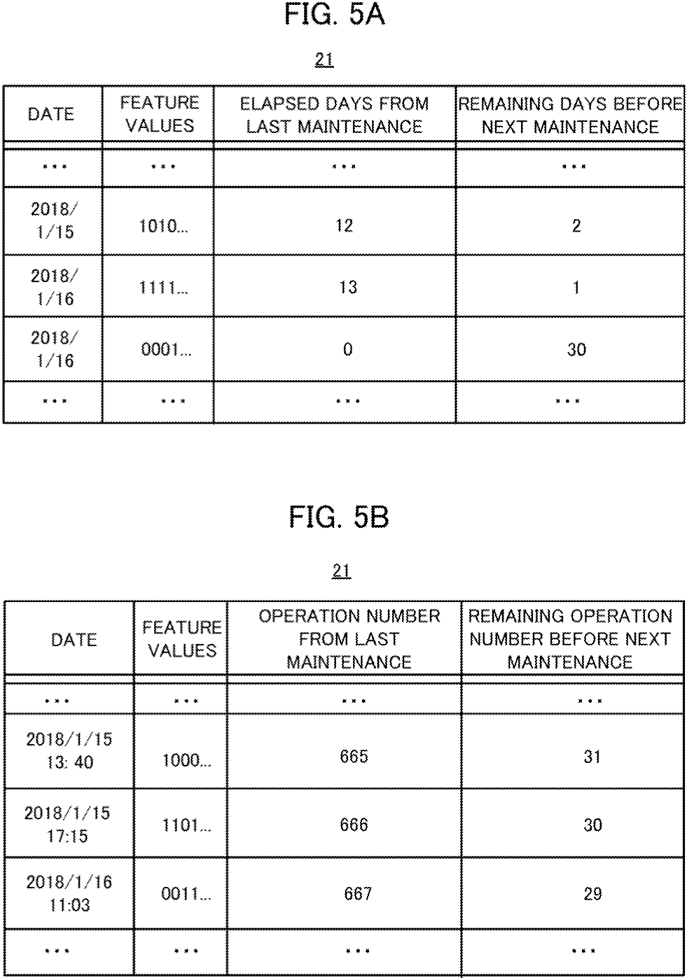

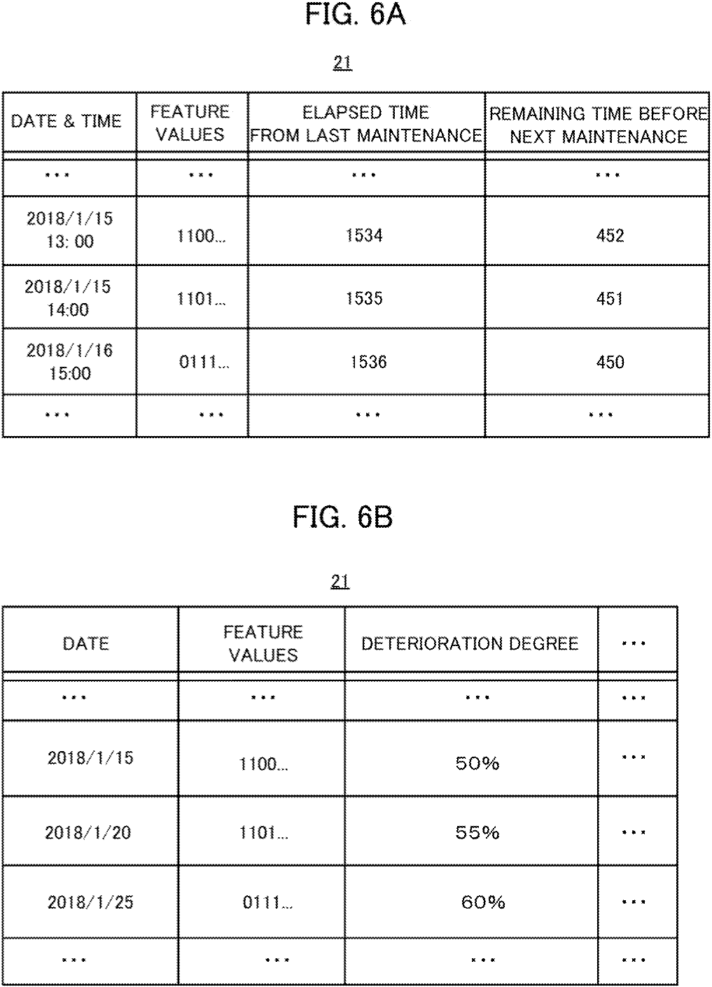

Next, a specific example of a data structure of the past data DB 21 (the first specific example to the fourth specific example) will be described with reference to FIGS. 5A, 5B, 6A and 6B.

FIG. 5A is a first specific example of the data structure of the past data DB 21. The maintenance target equipment 3 targeted in the first specific example is such equipment that the criterion of whether the maintenance is required or not depends on the number of operation days. The past data DB 21 according to the first specific example has items (fields) of “date”, “feature values”, “elapsed days from last maintenance”, and “remaining days before next maintenance”. Here, the data to be recorded in the item “feature values” corresponds to the first feature data Df1, and the data to be recorded in the other items (in FIG. 5A, “elapsed days from last maintenance” and “remaining days before next maintenance”) corresponds to the first maintenance information Im1. The same applies to each specific example described below.

The item “feature values” indicates feature values according to the first feature data Df1 generated by the feature extraction unit 61, and is represented herein by binary data as an example. The item “date” indicates the detection date of the detection signal Sa to be used for generating the corresponding feature values. The past data DB 21 may be provided with an item “date & time”, instead of the item “date”, indicating the detection date and time of the corresponding detection signal Sa.

The item “elapsed days from last maintenance” indicates the number of days elapsed from the date of the implementation of the last maintenance of the maintenance target equipment 3 to the date of detection of the corresponding detection signal Sa. The maintenance in this case refers to maintenance to restore the state of the maintenance target equipment 3 such as repair and parts replacement, and does not include an inspection without such maintenance. The item “remaining days before next maintenance” indicates the number of days from the detection date of the target detection signal Sa to the day when the next maintenance of the maintenance target equipment 3 was performed. The items “elapsed days from last maintenance” and “remaining days before next maintenance” indicate examples of information relating to a deterioration status of the maintenance target equipment 3. It is noted that the item “remaining days before next maintenance” is not an essential item in the present example embodiment. For example, if the maintenance is performed periodically in the past, the item “remaining days before next maintenance” may not be provided because “remaining days before next maintenance” can be uniquely derived from the interval of maintenance and “elapsed days from last maintenance”.

Thus, the past data DB 21 according to the first specific example shown in FIG. 5A includes records each associating the first feature data Df1 based on the detection signal Sa generated on a daily basis with the first maintenance information Im1 indicating the number of elapsed or remaining days with reference to the last or next maintenance.

FIG. 5B is a second specific example of the data structure of the past data DB 21. The maintenance target equipment 3 targeted in the second specific example is equipment (e.g., point-switch) configured to perform a predetermined operation as necessary, and the criterion of necessity of the maintenance thereof is based on the number of operations (operation number). Then, each time the maintenance target equipment 3 is operated a predetermined number of times (once in this case), the past data to be a record of the past data DB 21 is generated. The past data DB 21 according to the second specific example has items “date & time”, “feature values”, “operation number from last maintenance” and “remaining operation number before next maintenance”. The item “operation number from last maintenance” herein indicates the number of times the maintenance target equipment 3 was operated during the time period from the last maintenance to the detection of the target detection signal Sa. The item “remaining operation number before next maintenance” herein indicates the number of times the maintenance target equipment 3 was operated during the time period from the detection of the target detection signal Sa to the next maintenance. The items “operation number from last maintenance” and “remaining operation number before next maintenance” indicate examples of information relating to a deterioration status of the maintenance target equipment 3.

Thus, the past data DB 21 according to the second specific example includes records each associating the first feature data Df1 based on the detection signal Sa detected every time the maintenance target equipment 3 is operated with the first maintenance information Im1 indicating the number of operations of the maintenance target equipment 3 with reference to the last or next maintenance.

FIG. 6A is a third specific example of the data structure of the past data DB 21. The maintenance target equipment 3 targeted in the third specific example is such equipment that repeatedly switches between on-state and off-state, and the criterion of the necessity of maintenance thereof is based on the actual operation time. Then, each time the actual operation time of the maintenance target equipment 3 is increased by a predetermined time (here one hour), a record of the past data in the past data DB 21 is generated. The past data DB 21 according to the third specific example has items “date & time”, “feature values”, “elapsed time from last maintenance”, and “remaining time before next maintenance”. The item “elapsed time from last maintenance” herein indicates the actual operation time of the maintenance target equipment 3 during the time period from the time of the last maintenance to the detection time of the target detection signal Sa. The item “remaining time before next maintenance” herein indicates the actual operation time of the maintenance target equipment 3 during the time period from the time point of the generation of the target detection signal Sa to the time point of the next maintenance of the maintenance target equipment 3. The items “elapsed time from last maintenance” and “remaining time before next maintenance” indicate examples of information relating to a deterioration status of the maintenance target equipment 3.

Thus, the past data DB 21 according to the third specific example includes records each associating the first feature data Df1 with the first maintenance information Im1 indicating the actual operation time of the maintenance target equipment 3 with reference to the last or next maintenance.

FIG. 6B is a fourth specific example of the data structure of the past data DB 21. The maintenance target equipment 3 targeted in the fourth specific example may be any type of equipment. The past data DB 21 according to the fourth specific example includes at least the items “date”, “feature values” and “deterioration degree”.

“deterioration degree” is an index that indicates the degree of deterioration of the maintenance target equipment 3 by percentage from 0% to 100%. Here, 0% is a value that indicates the status immediately after maintenance, and 100% is a value that indicates the status that maintenance is immediately required. The deterioration degree to be registered in each field of the item “deterioration degree” may be a value entered by an inspector of the maintenance target equipment 3 or may be a value calculated from information relating to other maintenance. In the latter case, for example, the deterioration degree may be calculated based on the elapsed time (number of times or actual time) with reference to the last or next maintenance. For example, in the case of the record on Jan. 15, 2018 according to the first specific example shown in FIG. 5A, “elapsed days from last maintenance” is 12 and “remaining days before next maintenance” is 2. Thus, the deterioration degree becomes “85%” (≈ 12 / (12 + 2) * 100%).

Thus, provided that “elapsed days from last maintenance” is denoted by “N1” and “remaining days before next maintenance” is denoted by “N2”, the information addition unit 62 can calculate the deterioration degree “D” by the following equation.

$$\text{D} \text{=} \left\{\text{N1/} \left(\text{N1} \text{+} \text{N2}\right)\right\} \text{*} \text{100\%}$$

In the case of the second specific example shown in FIG. 5B, the deterioration degree D can be calculated according to the above equation by using the above N1 as “operation number from last maintenance” and the above N2 as “remaining operation number before next maintenance”. Similarly, in the case of the third specific example shown in FIG. 6A, the deterioration degree D can be calculated according to the above equation by using the above N1 as “elapsed time from last maintenance” and the above N2 as “remaining time before next maintenance”.

When the deterioration degree of the maintenance target equipment 3 at the execution timing of maintenance is recorded in the maintenance history DB 25 (e.g., when the maintenance executer records the deterioration degree of the maintenance target equipment 3 immediately before the maintenance), the information addition unit 62 calculates the deterioration degree D during the interval of the maintenance based on the recorded degrees of deterioration. Specifically, when the deterioration degree at the execution timing of the next maintenance is denoted by “D1”, the deterioration degree D at the timing other than the execution timing of the maintenance can be calculated according to the following equation.

$$\text{D} \text{=} \left\{\text{N1/} \left(\text{N1} \text{} \text{/} \text{+} \text{N2}\right)\right\} \text{*} \text{D} 1$$

In addition, if the maintenance history DB 25 does not have the item “remaining days before next maintenance”, the information addition unit 62 assumes that maintenance is performed periodically and calculates the deterioration degree on the assumption that the number of days from the last maintenance and the next maintenance is a fixed value. The maintenance executer may register, in the maintenance history DB 25, such information that the degradation degree corresponding to the past data immediately before or immediately after the occurrence of the failure of the maintenance target equipment 3 is 100%. The “deterioration degree” is an example of information relating to the deterioration status of the maintenance target equipment 3.

Thus, the past data DB 21 according to the fourth specific example shown in FIG. 6B has the item “deterioration degree” indicative of an index indicating the deterioration status regardless of the type of the maintenance target equipment 3. In addition to the item “deterioration degree”, the past data DB 21 may include items (e.g., “elapsed days from last maintenance”) indicating information relating to the degradation status of the maintenance target equipment 3 according to the first to third specific examples described above.

### Matching Result

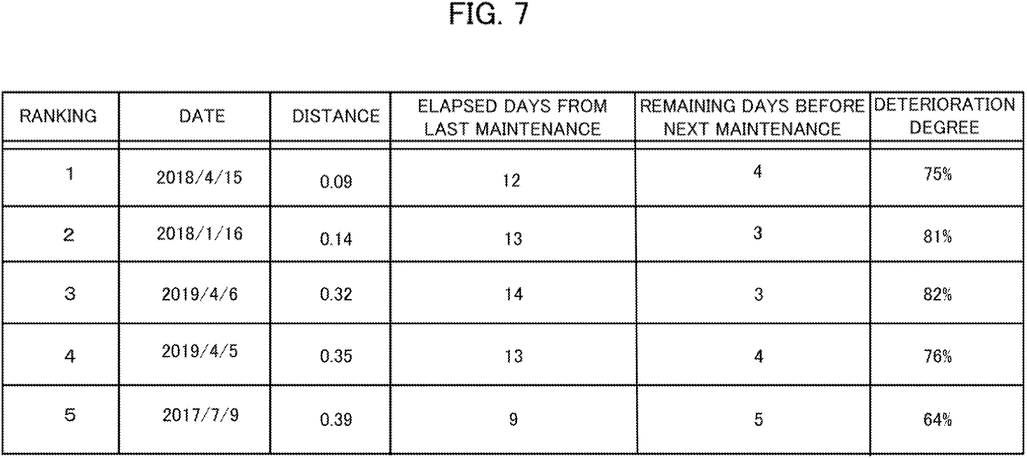

Next, a description will be given of a specific example of the matching result Rc obtained through the matching executed by the matching unit 32. FIG. 7 is a list showing the matching result Rc. Here, as an example, the matching unit 32 calculates the distance in the feature space as an index of similarity between the first feature data Df1 and the second feature data Df2. The matching unit 32 searches the past data DB 21 for records of the past data corresponding to first feature data Df1 having top fifteen degrees of the similarity (i.e., top fifteen short distance) to the second feature data Df2 and outputs the search result as the matching result Rc.

The list of past data shown in FIG. 7 has each item of “ranking”, “date”, “distance”, “elapsed days from last maintenance”, “remaining days before next maintenance” and “deterioration degree”. Here, as an example, the matching unit 32 adds information corresponding to each item “ranking” and “distance” to the past data including information corresponding to each item “date”, “elapsed days from last maintenance”, “remaining days before next maintenance” and “deterioration degree”. The item “ranking” indicates the ranking of the degree of similarity of the target past data in the past data DB 21. The item “distance” indicates the distance in the feature space between the first feature data Df1 of the target past data and the second feature data Df2.

The matching unit 32 may calculate the deterioration degree based on other information included in the past data even when the past data registered in the past data DB 21 does not include the information on the deterioration degree. In this case, the matching unit 32 may calculates the deterioration degree using information on the items “elapsed days from last maintenance”, “remaining days before next maintenance” in the same way as the information addition unit 62 does according to the description of the data structure of the past data DB 21 in the fourth specific example described above.

The matching unit 32 supplies the matching result Rc as illustrated in FIG. 7 to the display control unit 33, thereby providing the display control unit 33 with information on maintenance of the maintenance target equipment 3 in the past in a similar condition to the state of the current maintenance target equipment 3.

In the case where the number of operations, instead of the number of days, is used as a criterion for the necessity of maintenance of the maintenance target equipment 3, the items “elapsed days from last maintenance”, “remaining days before next maintenance” in FIG. 7 are replaced by the items “operation number from last maintenance”, “remaining operation number before next maintenance”, respectively. Similarly, in the case where the actual operation time, instead of the number of days, is used as a criterion for the necessity of maintenance of the maintenance target equipment 3, the items “elapsed days from last maintenance”, “remaining days before next maintenance” in FIG. 7 are replaced by the items “elapsed time from last maintenance”, “remaining time before next maintenance”, respectively.

### Preventive Maintenance Support View

Next, a description will be given of display examples (first display example to sixth display example) of the preventive maintenance support view displayed by the display device 4 based on the display signal Sb generated by the display control unit 33. The display example described below may be arbitrarily combined.

### First Display Example

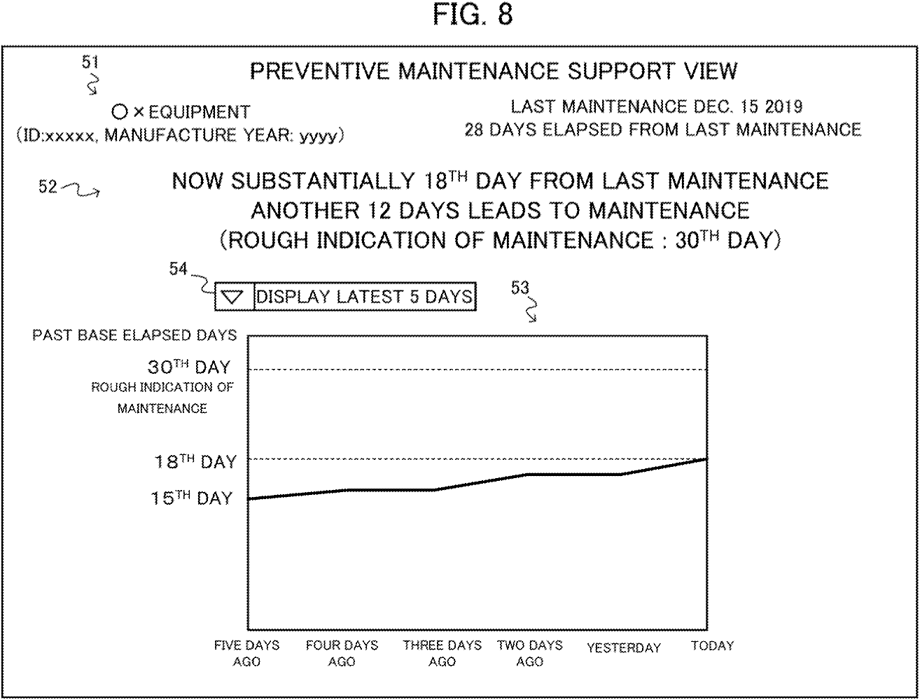

FIG. 8 is a first display example of the preventive maintenance support view displayed on the display device 4. The display control unit 33 transmits the generated display signal Sb via the interface 13 to the display device 4, thereby displaying on the display device 4 the preventive maintenance support view including basic information 51, a maintenance related comment 52, and a maintenance related graph 53.

The basic information 51 is basic information of the maintenance target equipment 3 subjected to preventive maintenance support. Here, as an example, the display control unit 33 generates the basic information 51 that includes the device ID and the year of manufacture of the maintenance target equipment 3, and the date and time of the last maintenance, and the elapsed date and time from the last maintenance. Information relating to the basic information 51 (including the date of implementation of the last maintenance) is stored in advance, for example, in the storage device 2 or the like.

The maintenance related comment 52 is a comment indicative of the deterioration status of the maintenance target equipment 3 and the timing at which the maintenance is required based on the past data of the maintenance target equipment 3 recorded in the past data DB 21. The display control unit 33 includes, in the maintenance related comments 52, the number of days (also referred to as “past-base elapsed days”) elapsed from the last maintenance corresponding to the current state of the maintenance target equipment 3 with reference to the past data and the remaining operation number of days (also referred to as “past-base remaining days”) before the next maintenance of the maintenance target equipment 3 with reference to the past data.

In this case, by aggregating the matching result Rc (specifically the values of “elapsed days from last maintenance”) generated by the matching unit 32, the display control unit 33 determines that the past-base elapsed days is eighteen days (i.e., the current state of the maintenance target equipment 3 is the state of eighteenth days from the last maintenance). Therefore, in this case, the display control unit 33 generates a maintenance related comment 52 including a text statement “now substantially 18^{th} day from last maintenance”. Further, since the maintenance is periodically performed every 30 days according to the past data of the maintenance target equipment 3 recorded in the past data DB 21, the display control unit 33 determines the timing of maintenance to be the timing when the past-base elapsed days reaches 30 days. Therefore, in this case, since the past-base elapsed days is eighteen days, the display control unit 33 determines the past-base remaining days to be twelve days (= 30 - 18). Therefore, in this case, the display control unit 33 generates a maintenance related comment 52 including a text statement “another 12 days leads to maintenance (rough indication of maintenance 30 ^{th} day).” If the past data includes information relating to “remaining days before next maintenance” (see FIG. 5A), the display control unit 33 may determine the past-base remaining days to be representative value, such as an average value and a weighted average value, of the remaining days before next maintenance according to the past data included in the matching result Rc.

Further, the display control unit 33 stores, in the maintenance estimate history DB 22, second maintenance information Im2 that is information indicative of the deterioration status (past-base elapsed days in this case) of the maintenance target equipment 3 estimated based on the matching result Rc and the next timing of maintenance (in this case the past-base remaining days). At this time, the display control unit 33 stores the second maintenance information Im2 associated with the information indicating the present date and time (or date) in the maintenance estimate history DB 22.

The maintenance related graph 53 is a graph showing the transition of the estimated deterioration status of the maintenance target equipment 3. Here, as an example, the display control unit 33 extracts, from the maintenance estimate history DB 22, the second maintenance information Im2 indicating the estimated result of the deterioration status of the maintenance target equipment 3 for the last five days including the present date, and displays the maintenance related graph 53 based on the extracted second maintenance information Im2. Specifically, the display control unit 33 displays a line graph showing the transition of the past-base elapsed days for the past five days extracted from the maintenance estimate history DB 22 as the maintenance related graph 53. Thus, the display control unit 33 allows a user of the display device 4 to suitably grasp the transition of the past-base elapsed days.

Further, the display control unit 33 displays a period selection field 54 in the pull-down menu format for selecting the period targeted in the maintenance related graph 53 in the vicinity of the maintenance related graph 53. Then, the display control unit 33 immediately updates the display of the maintenance related graph 53 in response to the change of the selection menu in the period selection field 54. For example, the display control unit 33 may provide, as selectable menus in the period selection field 54, not only “display last 5 days” but also “display last 10 days” and “entire period from last maintenance”.

Here, a supplementary description will be given of a method for calculating the past-base elapsed days from the matching result Rc.

In the first example for calculating the past-base elapsed days from the matching result Rc, the display control unit 33 determines the past-base elapsed days to be the average value of “elapsed days from last maintenance” included in a predetermined number of the past data selected in descending order of the degree of the similarity indicated by the matching result Rc. When the matching result Rc shown in FIG. 7 is obtained, the past-base elapsed days based on the first example is 10.6 (= {12 + 13 + 14 + 13 + 9} / 5) days.

In the second example for calculating the past-base elapsed days from the matching result Rc, the display control unit 33 determines the past-base elapsed days to be the weighted average value of “elapsed days from last maintenance” included in a predetermined number of the past data selected in descending order of the degree of similarity indicated by the matching result Rc. In this case, for example, the display control unit 33 sets the weight based on the similarity (distance in FIG. 7) as the weight for each “elapsed days from last maintenance”. In this case, for example, when the inverse number of the distance is set as the weight for each “elapsed days from last maintenance”, the past-base elapsed days calculated based on the matching result Rc shown in FIG. 7 is 12.3 (≈ {12 / 0.09 + 13 / 0.14 + 14 / 0.32 + 13 / 0.35 + 9 / 0.39} / 26.8) days. In this case, the display control unit 33 can calculate the past-base elapsed days by increasing the weight with increasing similarity of the past data.

In another example of weighting, the display control unit 33 sets the weight for “elapsed days from last maintenance” based on the ranking of the degree of the similarity. In this case, the display control unit 33 increases the weight for “elapsed days from last maintenance” with climbing ranking of the degree of the similarity. For example, it is assumed herein that the weight is set to “5” for the first place of the ranking of the similarity, the weight is set to “4” for the second place of the ranking of the similarity, the weight is set to “3” for the third place of the ranking of the similarity, the weight is set to “2” for the fourth place of the ranking of the similarity, and the weight is set to “1” for the fifth place of the ranking of the similarity. In this case, the past-base elapsed days is 12.6 days (= { 12 * 5 + 13 * 4 + 14 * 3 + 13 * 2 + 9 * 1} / 15). In this case as well, the display control unit 33 can calculate the past-base elapsed days by increasing the weight with climbing ranking of the degree of the similarity of the past data.

In the case of calculating the past-base elapsed days from “remaining days before next maintenance” indicated by the matching result Rc, the display control unit 33 can also calculate the past-base elapsed days by applying the averaging process based on the first example or second example described above. The display control unit 33 may determine the past-base elapsed days or past-base remaining days to be the representative value such as the median other than the average value (including the weighted average value).

### Second Display Example

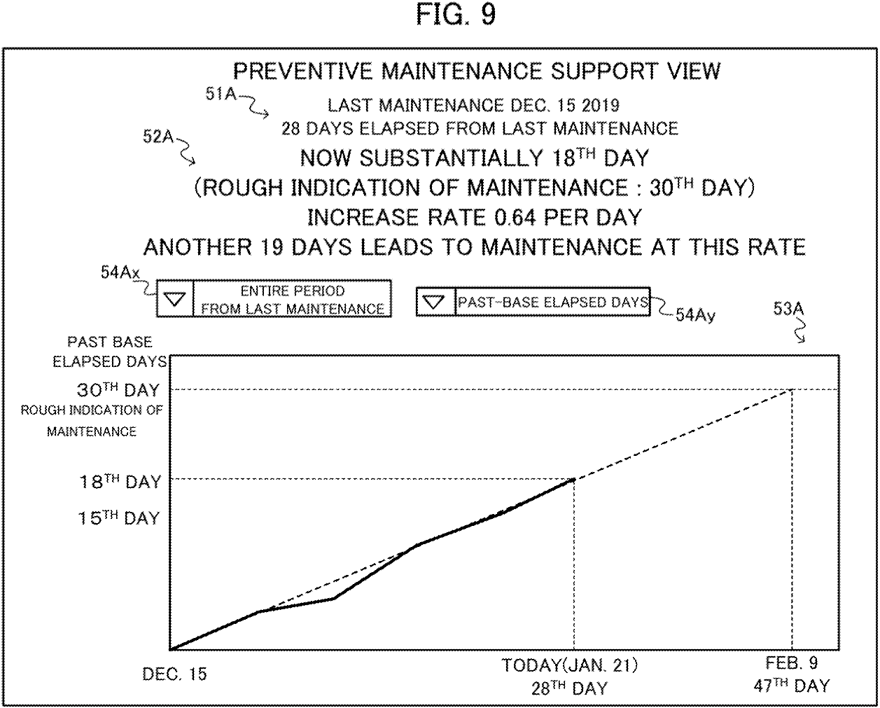

FIG. 9 is a second display example of the preventive maintenance support view displayed on the display device 4. According to the second display example, the display control unit 33 performs calculation and display of the past-base elapsed days in consideration of the increase rate of the past-base elapsed days. The display control unit 33 transmits the generated display signal Sb via the interface 13 to the display device 4 and thereby displays on the display device 4 the preventive maintenance support view including basic information 51A, a maintenance related comment 52A, and a maintenance related graph 53A. The basic information 51A is the same as the basic information 51 according to the first display example.

The display control unit 33 displays the preventive maintenance support view includes not only the past-base elapsed days and the past-base remaining days but also the maintenance related comment 52A indicative of the increase (simply referred to as “increase rate”) in the past-base elapsed days per actual day (for one actual day). Here, the display control unit 33 determines the above-mentioned increase rate to be the increase (here 0.64) in the past-base elapsed day per one day of actually-elapsed days (here 28 days) from the last maintenance. The display control unit 33 refers to the maintenance estimate history DB 22 and extracts the past-base elapsed days corresponding to a predetermined number of latest days including the present date, and calculates, as the above-described increase rate, the increase in the extracted past-base elapsed days per actually-elapsed one day.

Further, the display control unit 33 calculates the past-base remaining days in consideration of the increase rate described above. Specifically, considering that the past-base elapsed days is eighteen days and the above-described increase rate is 0.64, the display control unit 33 determines that it takes about nineteen days (≈ {30 - 18} / 0.64) for the past-base elapsed days to become 30 days that is the rough indication of maintenance. Thus, the display control unit 33 can determine the past-base remaining days by accurately considering the degree of progress of the actual deterioration of the maintenance target equipment 3.

Further, in the example of FIG. 9, the display control unit 33 extracts from the maintenance estimate history DB 22 the second maintenance information Im2 indicative of the estimation result of the deterioration status of the maintenance target equipment 3 during the entire time period from the last maintenance, and generates the maintenance related graph 53A based on the second maintenance information Im2. Further, the display control unit 33 displays the maintenance related graph 53A which indicates, by a broken line, the regressive transition of the past-base elapsed days when using the above-described increasing rate and which indicates, by a solid line, the transition of the past-base elapsed days calculated during the time period from the time of the last maintenance to the present time.

Further, the display control unit 33 provides a period selection field 54Ax in the pull-down menu format for selecting the target period subjected to calculation of the increase rate, and a graph selection field 54Ay for selecting the index (in this case, the past-base elapsed days) of the vertical axis of the graph to be displayed as the maintenance related graph 53A. The period selection field 54Ax has the same function as the period selection field 54 of the first display example. The display control unit 33 calculates, as the above-mentioned increase rate, increase in the past-base elapsed days per actual day calculated during the time period designated by the period selection field 54Ax. The graph selection field 54Ay also has various selectable menus such as “increase rate”, “past base elapsed days + increase rate”, and “deterioration degree” in addition to “past base elapsed days”.

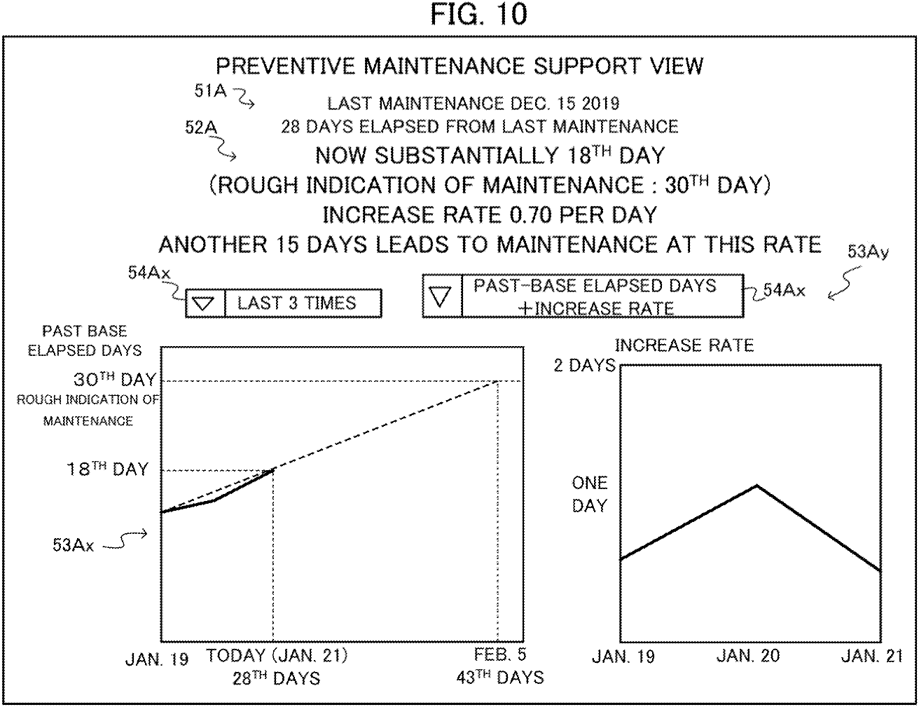

FIG. 10 is a display example of the preventive maintenance support view when “last 3 times” is selected in the period selection field 54Ax and “past base elapsed days + increase rate” is selected in the graph selection field 54Ay.

In this case, based on the selection result in the graph selection field 54Ay, the display control unit 33 provides, on the preventive maintenance support view, the first maintenance related graph 53Ax having the vertical axis of the past-base elapsed days, and a second maintenance related graph 53Ay having the vertical axis of the increase rate. Further, based on the selection result in the period selection field 54Ax, the display control unit 33 extracts the latest three records of the second maintenance information Im2 including the present calculation result from the maintenance estimate history DB 22, and displays the first maintenance related graph 53Ax and the second maintenance related graph 53Ay based on the extracted second maintenance information Im2. Further, the display control unit 33 calculates the past-base remaining days (here fifteen days) based on the increase rate (here 0.70) calculated from the transition of the past-base elapsed days according to the latest three records of the second maintenance information Im2 and the past-base elapsed days (here 18 days) calculated at this time. Then, the display control unit 33 updates the maintenance related comment 52A based on the above-described increase rate, the past-base elapsed days, and the past-base remaining days.

Thus, in the second display example, the display control unit 33 can suitably present the increase rate and the past-base elapsed days in consideration of the increase rate to the user of the display device 4.

### Third Display Example

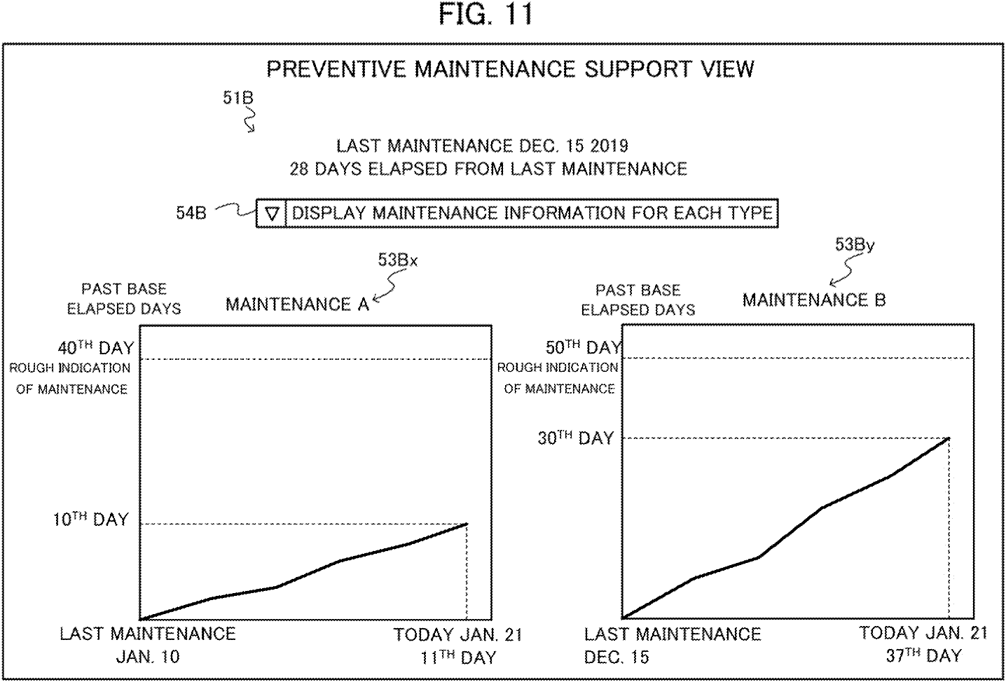

FIG. 11 is a third display example of the preventive maintenance support view displayed on the display device 4. In the third display example, the display control unit 33 displays information on maintenance for each type of maintenance for the maintenance target equipment 3. The type of maintenance may be different for each component subject to maintenance, for example. The display control unit 33 transmits the generated display signal Sb to the display device 4 via the interface 13, and thereby displays the preventive maintenance support view including basic information 51B, a first maintenance related graph 53Bx, a second maintenance related graph 53By, and a display information selection field 54B on the display device 4.

In this case, the display control unit 33 displays graphs relating to maintenance for each type of maintenance (herein, maintenance A and maintenance B) of the maintenance target equipment 3 since “display maintenance information for each type” is selected in the display information selection field 54B. Specifically, the display control unit 33 provides the first maintenance related graph 53Bx for the maintenance A and the second maintenance related graph 53By for the maintenance B on the preventive maintenance support view. In this case, the past data for each type of maintenance is recorded in the past data DB 21, and the matching unit 32 matches the second feature data Df2 generated based on the detection signal Sa required for each type of maintenance with the past data described above to thereby generate the matching result Rc for each type of maintenance. Then, the display control unit 33 generates the first maintenance related graph 53Bx and the second maintenance related graph 53By based on the matching result Rc for each type of maintenance and the second maintenance related information Im2 recorded in the maintenance estimate history DB 22 for each type of maintenance.

According to the selection result in the display information selection field 54B, the display control unit 33 may display maintenance information of the entire maintenance target equipment 3 on the preventive maintenance support view or may display the maintenance information of each type of the maintenance target equipment 3 together with the entire maintenance information of the maintenance target equipment 3 on the preventive maintenance support view. In this case, for example, the past data DB 21 stores not only the past data for each type of maintenance but also the past data for the maintenance of the entire maintenance target equipment 3. Then, the matching unit 32 generates the matching result Rc regarding the entire maintenance target equipment 3 by matching the second feature data Df2 generated based on the detection signal Sa required for the entire maintenance of the maintenance target equipment 3 with the past data described above. Then, based on the matching result Rc regarding the entire maintenance target equipment 3 and the second maintenance information Im2 previously recorded in the maintenance estimate history DB 22, the display control unit 33 displays, on the preventive maintenance support view, a maintenance related graph showing the past-base elapsed days of the entire maintenance target equipment 3.

Thus, according to the third display example, the display control unit 33 can suitably present the information regarding the maintenance of each type of the maintenance target equipment 3 to the user of the display device 4.

### Fourth Display Example

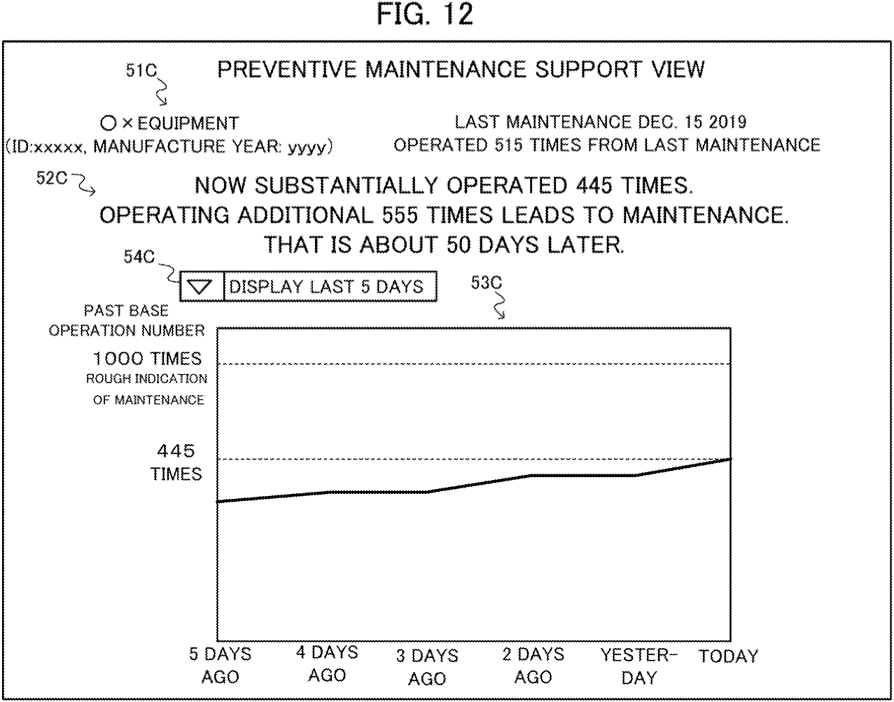

FIG. 12 is a fourth display example of the preventive maintenance support view displayed on the display device 4. In the fourth display example, the display control unit 33 displays, instead of the number of days, information relating to maintenance of the maintenance target equipment 3 based on the number of operations of the maintenance target equipment 3. The display control unit 33 transmits the generated display signal Sb to the display device 4 via the interface 13, and thereby displays the preventive maintenance support view including basic information 51C, a maintenance related comment 52C, and a maintenance related graph 53C on the display device 4.

In this case, the display control unit 33 calculates: the number of operations (also referred to as “past-base operation number”), with reference to the past data, of the maintenance target equipment 3 in the current state from the last maintenance; and the number of remaining operations (also referred to as “past-base remaining times”), with reference to the past data, of the maintenance target equipment 3 before the next maintenance. Then, the display control unit 33 generates the maintenance related comment 52C indicating the calculated past-base operation number and the past-base remaining operation number. In this case, the display control unit 33 aggregates the matching result Rc (specifically the value of “operation number from last maintenance”) generated by the matching unit 32 and thereby determines that past-base operation number is 445 times (actual operation number is 515 times). Therefore, in this case, the display control unit 33 generates the maintenance related comment 52 including a text sentence stating “now substantially operated 445 times”.

The method of calculating the past-base operation number from the matching result Rc is the same as the method of calculating the past-base elapsed days from the matching result Rc. Specifically, the display control unit 33 calculates, as the past-base operation times, the average value, weighted average value, or any other representative value of the “operation number from last maintenance” (see FIG. 5B) included in a predetermined number of the past data selected in descending order of the degree of similarity.

Further, considering the fact that maintenance is performed periodically every 1000 operation times according to the past data of the maintenance target equipment 3 recorded in the past data DB 21, the display control unit 33 determines the maintenance should be performed if the past-base operation times reaches 1000 times. Thus, in this case, the display control unit 33 obtains the past-base remaining operation number by subtracting the past-base operation number that is 445 times from 1000 times, and thereby generates the maintenance related comment 52C including a text sentence “operating additional 555 times leads to maintenance”. If the matching result Rc includes information relating to “remaining operation number before next maintenance”, the display control unit 33 may determines the past-base remaining operation number to be the average value, weighted average value, or any other representative value of “remaining operation number before next maintenance”. Further, based on the number of actual days elapsed from the last maintenance day and the past-base operation number and the past-base remaining operation number calculated at this time, the display control unit 33 calculates the number of remaining days before the next maintenance and includes a sentence “that is about 50 days later” in the maintenance related comment 52C.

The display control unit 33 may calculate the increase rate in the same way described in the second display example and calculate the past-base remaining operation number in consideration of the increase rate. The increase rate herein indicates the increase in the past-base operation number for one actual operation of the maintenance target equipment 3.

Further, the display control unit 33 generates the maintenance related graph 53C based on a predetermined number of latest records of the second maintenance information Im2 stored in the maintenance estimate history DB 22. Here, as an example, the maintenance estimate history DB 22 stores daily second maintenance information Im2 including the past-base operation number and the past-base remaining operation number generated based on the matching result Rc on a daily basis, and the display control unit 33 generates the maintenance related graph 53C based on the daily second maintenance information Im2. The display control unit 33 recognizes, based on the selection result in the period selection field 54C, the time period (last five days in FIG. 12) in which the maintenance related graph 53C is targeted, and generate the maintenance related graph 53C in the time period.

Thus, according to the fourth display example, when the criterion for the necessity of the maintenance of the maintenance target equipment 3 is based on the number of operations, the display control unit 33 can suitably display information relating to maintenance of the maintenance target equipment 3 based on the number of operations of the maintenance target equipment 3. When the criterion for the necessity of the maintenance of the maintenance target equipment 3 is based on the actual operation time, the display control unit 33 may display information on the maintenance of the maintenance target equipment 3 based on the actual operation time of the maintenance target equipment 3 in the same manner as the fourth display example.

### Fifth Display Example

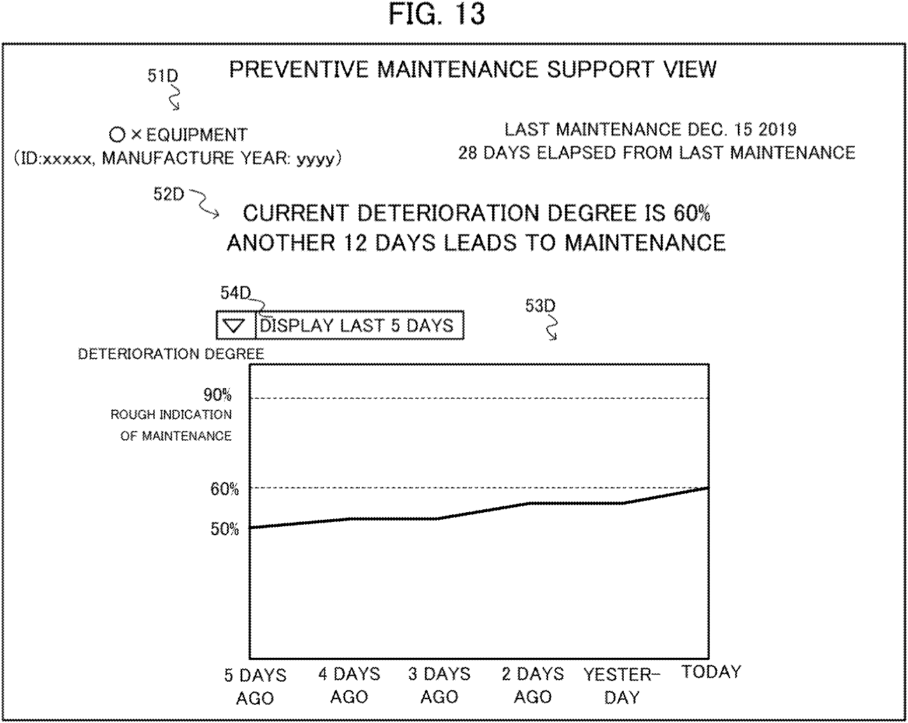

FIG. 13 is a fifth display example of the preventive maintenance support view displayed on the display device 4. In the fifth display example, the display control unit 33 displays, instead of the number of days, information relating to maintenance of the maintenance target equipment 3 based on the deterioration degree of the maintenance target equipment 3. The display control unit 33 transmits the generated display signal Sb to the display device 4 via the interface 13, and displays the preventive maintenance support view including basic information 51D, a maintenance related comment 52D, and a maintenance related graph 53D on the display device 4.

The display control unit 33 calculates, for the maintenance related comment 52D, the deterioration degree (here 60%) corresponding to the current state of the maintenance target equipment 3 and the number of remaining days before the next maintenance (here 12 days) estimated from the deterioration degree. In this case, for example, the matching result Rc includes information on deterioration degrees included in a predetermined number of the past data selected in descending order of the degree of similarity, and the display control unit 33 determines the deterioration degree to be displayed as the maintenance related comment 52D to be the average value, the weighted average value, or any other representative value of the deterioration degrees. Further, for example, by referring to a table or the like indicating the correspondence between the deterioration degree and the remaining days described above, the display control unit 33 determines the remaining days (i.e., the past-base remaining days) before the next maintenance based on the determined deterioration degree. The above table or the like is stored in advance, for example, in the storage device 2 or the memory 12. If the matching result Rc includes information relating to “remaining days before next maintenance”, the display control unit 33 may determine the remaining days described above to be the average value, weighted average value, or any other representative value of “remaining days before next maintenance”.

Further, the display control unit 33 generates a maintenance related graph 53D based on a predetermined number (here, five days) of the lastest second maintenance information Im2 stored in the maintenance estimate history DB 22. Here, the maintenance estimate history DB 22 stores daily second maintenance information Im2 including the deterioration degree determined based on the matching result Rc on a daily basis and the display control unit 33 generates the maintenance related graph 53D based on the second maintenance information Im2 for the last five days stored in the maintenance estimate history DB 22. The display control unit 33 determines, based on the selection result in the period selection field 54D, a time period (in FIG. 13 the last five days) in which the maintenance related graph 53D is targeted, and generates a maintenance related graph 53D in the time period.

Thus, in the fifth display example, by using the degradation degree as a criterion for the necessity of the maintenance of the maintenance target equipment 3, the display control unit 33 can allow the user of the display device 4 to accurately recognize the necessity of the maintenance based on the current state of the maintenance target equipment 3.

### Sixth Display Example

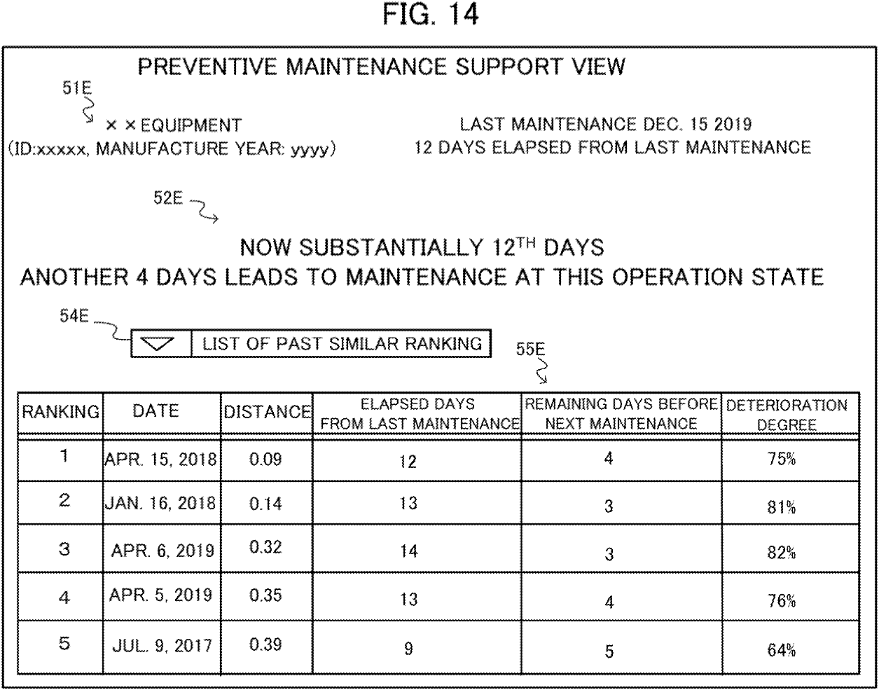

FIG. 14 is a sixth display example of the preventive maintenance support view displayed on the display device 4. In the sixth display example, the display control unit 33 displays a list of the past data in descending order of the degree of the similarity indicated by the matching result Rc as the information relating to maintenance of the maintenance target equipment 3. The display control unit 33 transmits the generated display signal Sb to the display device 4 via the interface 13, and displays the preventive maintenance support view including basic information 51E, a maintenance related comment 52E, and maintenance related list information 55E on the display device 4.

The display control unit 33 calculates, in the same manner described in the first display example, the past-base elapsed days corresponding to the current state of the maintenance target equipment 3 and the past-base remaining days that is remaining days before the next maintenance estimated from the past data. Then, the display control unit 33 displays the calculated information on the preventive maintenance support view as the maintenance related comment 52E.

Further, since the item “list of past similar ranking” is selected in the display content selection field 54E, the display control unit 33 displays the maintenance related list information 55E that is a list of the top five records of the past data according to the similarity indicated by the matching result Rc. Here, similarly to the matching result Rc shown in FIG. 7, the display control unit 33 displays the maintenance related list information 55E including the items “ranking”, “date”, “distance”, “elapsed days from last maintenance”, “remaining days before next maintenance”, and “deterioration degree” on the preventive maintenance support view. Based on the selection result in the display content selection field 54E, the display control unit 33 may display the maintenance related graph based on at least one of the first to fifth display examples on the preventive maintenance support view.

Even according to this mode, the display control unit 33 suitably presents information on the maintenance of the past data similar to the current state of the maintenance target equipment 3, suitably supporting the determination of the maintenance plan of the maintenance target equipment 3.

Further, if there is any record of the past data whose deterioration degree is higher than a predetermined degree among the records of the past data with higher similarity to be listed on the maintenance related list information 55E, the display control unit 33 may display an attention informing the user of the presence of the any record of past data on the preventive maintenance support view.

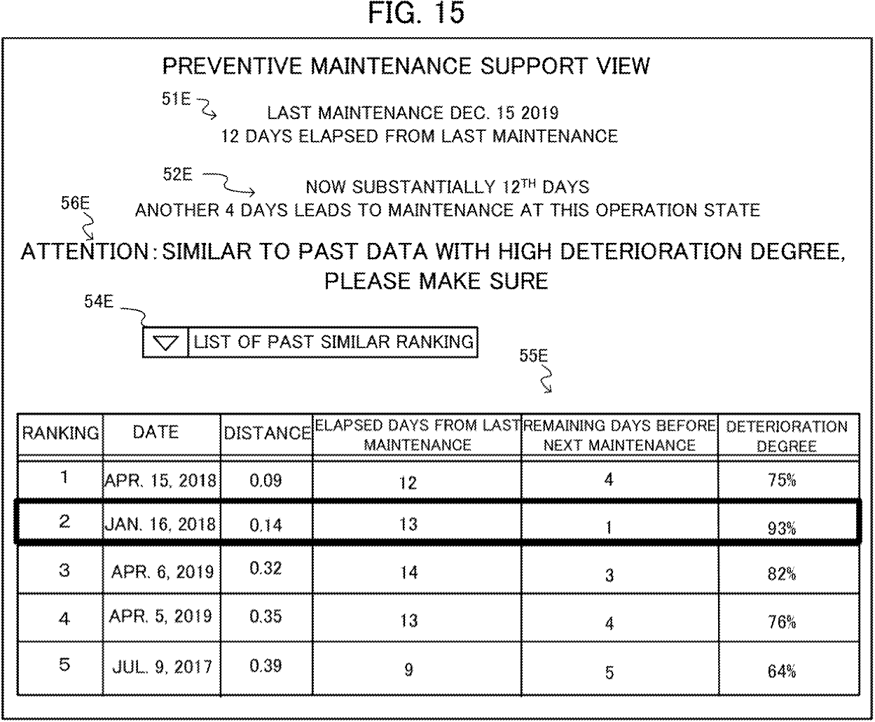

FIG. 15 shows the preventive maintenance support view according to the sixth display example in the case where there is a record of past data in which the remaining days before the next maintenance is shorter than the threshold value. In the example of FIG. 15, since the deterioration degree of the past data corresponding to the second record of the maintenance related list information 55E is higher than a predetermined threshold value (90%), the display control unit 33 displays the attention information 56E regarding the necessity for maintenance on the preventive maintenance support view. Specifically, as the attention information 56E, the display control unit 33 displays a text stating “similar to past data with high deterioration degree, please make sure” on the preventive maintenance support view. Further, the display control unit 33 highlights the second record of the maintenance related list information 55E by the edging effect.

According to the example in FIG. 15, the display control unit 33 can let the user of the display device 4 suitably recognize the presence of a record of the past data having a deterioration degree higher than a predetermined degree among the records of the past data having higher degree of similarity. The display control unit 33 may determine, instead of determining the necessity of displaying the attention information 56E based on the deterioration degree, the necessity of displaying the attention information 56E based on whether or not the “remaining days before maintenance” is less than a predetermined number of days. In another example, when the necessity of the maintenance of the maintenance target equipment 3 is determined based on the operation number, the display control unit 33 may determines whether or not to display the attention information 56E by determining whether or not the “remaining operation number before next maintenance” (see FIG. 5B) is equal to or smaller than a predetermined number of times. In yet another example, when the actual operation time is used as a criterion for the necessity of the maintenance of the maintenance target equipment 3, the display control unit 33 may determines whether or not to display the attention information 56E by determining whether or not the “remaining time before next maintenance” (see FIG. 6A) is equal to or smaller than a predetermined time. Even if the display control unit 33 does not display the maintenance related list information 55E, the display control unit 33 may determine whether or not to display the attention information 56E and display the attention information 56E when it is determined to display the attention information 56E.

### Processing Flow

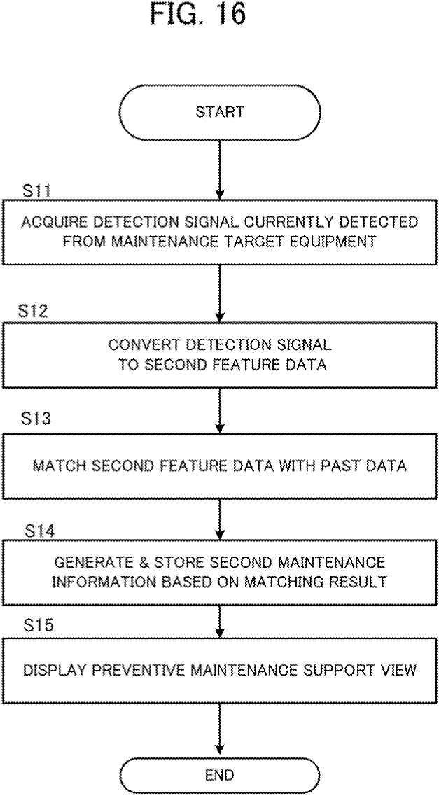

FIG. 16 is an example of a flowchart showing a processing procedure executed by the processor 11 of the information processing device 1. The processor 11 repeatedly executes the processing of the flowchart shown in FIG. 16.

First, the feature extraction unit 31 of the processor 11 acquires, from the state detection sensor 5 via the interface 13, the detection signal Sa which is time series data of one or more physical quantities currently detected from maintenance target equipment 3 (step S11). Then, the feature extraction unit 31 converts the detected signal Sa acquired at step S11 into the second feature data Df2 (step S12). In this case, the feature extraction unit 31 configures the feature converter by referring to the feature converter parameter information 20 and inputs the detection signal Sa to the feature converter, thereby acquiring the second feature data Df2.

Next, the matching unit 32 matches the second feature data Df2 generated at step S12 with the past data that is each record of the past data DB 21 (step S13). Thereby, the matching unit 32 calculates the degree of similarity between the first feature data Df1 included in the past data that is each record of the past data DB 21 and the second feature data Df2, and generates the matching result Rc corresponding to a predetermined number of records of the past data selected in descending order of the degree of similarity.

Then, the display control unit 33 generates the second maintenance information Im2 based on the matching result Rc indicating the predetermined number of the records of the past data selected in descending order of the degree of similarity, and stores, in the maintenance estimate history DB 22, the second maintenance information Im2 associated with the date and time information indicating the present date or date and time (step S14). Then, the display control unit 33 displays, based on the second maintenance information Im2 generated at step S14, the preventive maintenance support view on the display device 4 (step S15). In this case, the display control unit 33 generates the display signal Sb based on the processing described in the section “(6) Preventive Maintenance Support View”, and transmits the generated display signal Sb to the display device 4 thereby to display the preventive maintenance support view on the display device 4.

### Second Example Embodiment

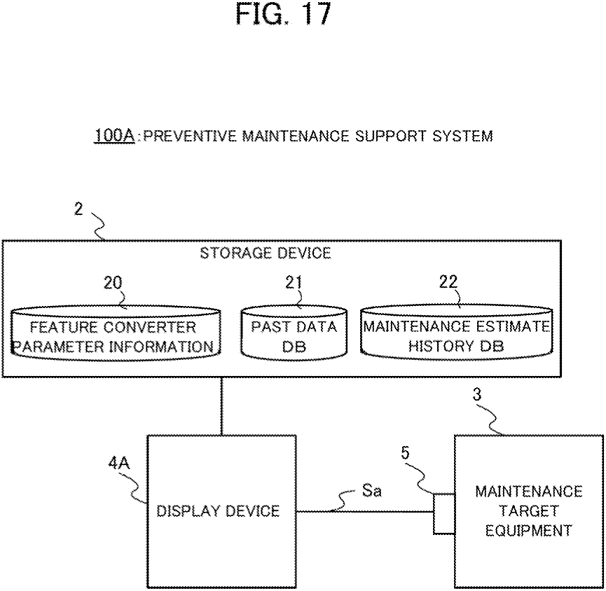

FIG. 17 shows a schematic configuration of a preventive maintenance support system 100A according to the second example embodiment. The preventive maintenance support system 100A includes a storage device 2, maintenance target equipment 3, a display device 4A, and a state detection sensor 5. Hereinafter, the same components as the preventive maintenance support system 100 according to the first example embodiment are appropriately denoted by the same reference numerals, and description thereof will be omitted.

In the second example embodiment, the display device 4A has both functions of the information processing device 1 and the display device 4 according to the first example embodiment. The hardware configuration of the display device 4A is the same as the hardware configuration of the display device 4 shown in FIG. 2B. Then, the display device 4A refers to the feature converter parameter information 20 stored in the storage device 2, the past data DB 21 and the maintenance estimate history DB 22, and executes the processing of the flowchart shown in FIG. 16 using the detection signal Sa indicative of the state of the present maintenance target equipment 3 outputted by the state detection sensor 5. In this case, the processor 41 of the display device 4A functions as the feature extraction unit 31, the matching unit 32, and the display control unit 33 shown in FIG. 3. Then, the display device 4A displays the preventive maintenance support view based on at least one of the first display example to the sixth display example described in the first example embodiment. Thus, the preventive maintenance support system 100A according to the second example embodiment can suitably support the preventive maintenance of the maintenance target equipment 3.

### Third Example Embodiment

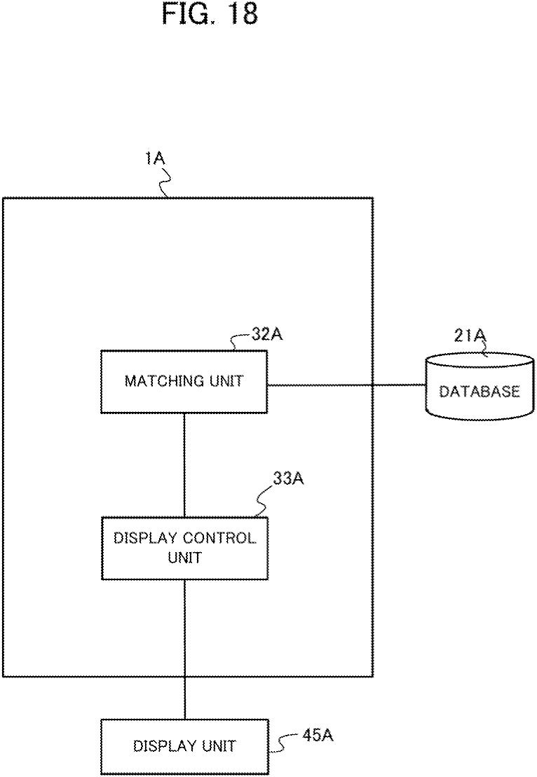

FIG. 18 is a schematic configuration diagram of an information processing device 1A according to the third example embodiment. As shown in FIG. 18, the information processing device 1A mainly includes a matching unit 32A and a display control unit 33A.

The matching unit 32A is configured to match a database 21A, which associates first detection data indicative of a past state of maintenance target equipment 3 with first maintenance information relating to maintenance of the maintenance target equipment 3 in the past state, with second detection data indicative of a current state of the maintenance target equipment 3. The database 21A is, for example, the past data DB 21 in the first example embodiment, and has a data structure based on at least one of FIGS. 5A to 6B.

In the first example, the first detection data is the first feature data Df1 indicating feature values of the detection signal Sa detected from the maintenance target equipment 3 in the past in the first example embodiment, and the second detection data is the second feature data Df2 indicating the feature values of the detection signal Sa currently detected from the maintenance target equipment 3. In this case, in the same way as the matching unit 32 in the first example embodiment does, the matching unit 32A performs the above-described matching by calculating the distance in the feature space between the first feature data Df1 and the second feature data Df2 as the degree of similarity thereof. In the second example, the first detection data is the detection signal Sa according to the first example embodiment detected from the maintenance target equipment 3 in the past, and the second detection data is the detection signal Sa currently detected from the maintenance target equipment 3. In this case, the matching unit 32A performs the above-described matching by calculating the similarity between the first detection data and the second detection data, which are time-series data, using any method (e.g., a cross-correlation function) to be used to determine the similarity between the signals.

The display control unit 33A is configured to display, based on a result of the matching by the matching unit 32A, second maintenance information relating to maintenance in accordance with the current state of the maintenance target equipment 3 on a display unit 45A. Examples of the display control unit 33A include the display control unit 33 in the first example embodiment. In this case, the display control unit 33A transmits a display signal including the second maintenance information Im2 to the display unit 45A thereby to display the preventive maintenance support view based on at least one of the first display example to the sixth display example on the display unit 45A.

Thus, even according to the third example embodiment, the information processing device 1A can suitably display information for supporting the preventive maintenance of the maintenance target equipment 3.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments (including modifications, the same shall apply hereinafter) described above can be described as, but not limited to, the following Supplementary Notes.

### Supplementary Note 1

An information processing device comprising:
a matching unit configured to match
   a database, which associates first detection data indicative of a past state of maintenance target equipment with first maintenance information relating to maintenance of the maintenance target equipment in the past state,
   with second detection data indicative of a current state of the maintenance target equipment; and
a display control unit configured to display, based on a result of the matching, second maintenance information relating to maintenance in accordance with the current state of the maintenance target equipment on a display unit.

### Supplementary Note 2

The information processing device according to Supplementary Note 1,
wherein the first maintenance information includes information relating to a deterioration status of the maintenance target device in the past state, and
wherein the display control unit is configured to display the second maintenance information including the information relating to the deterioration status of the maintenance target device in the current state on the display unit.

### Supplementary Note 3

The information processing device according to Supplementary Note 2,
wherein the information relating to the deterioration status is information indicating at least one of
   the number of elapsed days from last maintenance,
   actual operation time of the maintenance target device from the last maintenance,
   the number of operations of the maintenance target device from the last maintenance, or
   a deterioration degree of the maintenance target device.

### Supplementary Note 4

The information processing device according to any one of Supplementary Notes 1 to 3,
wherein the matching unit is configured to output, as the result of the matching, the first maintenance information corresponding to a predetermined number of the first detection data in descending order of a degree of similarity to the second detection data, and
wherein the display control unit is configured to generate the second maintenance information based on the first maintenance information outputted as the result of the matching.

### Supplementary Note 5

The information processing device according to Supplementary Note 4,
wherein the display control unit is configured to generate the second maintenance information by weighting the first maintenance information based on
   the degree of the similarity or
   a ranking based on the degree of the similarity.

### Supplementary Note 6

The information processing device according to any one of Supplementary Notes 1 to 5,

wherein the display control unit is configured to display the second maintenance information including information indicating a timing of a next maintenance of the maintenance target device on the display unit.

### Supplementary Note 7

The information processing device according to Supplementary Note 6,
wherein the display control unit is configured to display on the display unit, as the information indicating the timing, information indicating at least one of
   the number of remaining days before the next maintenance,
   actual operation time of the maintenance target device before the next maintenance, or
   the number of operations of the maintenance target device before the next maintenance.

### Supplementary Note 8

The information processing device according to Supplementary Note 6 or 7,

wherein the display control unit is configured to determine the timing based on the second maintenance information generated for a predetermined number of times in the past.

### Supplementary Note 9

The information processing device according to any one of Supplementary Notes 1 to 8,

wherein the display control unit is configured to display the second maintenance information for each type of the maintenance target device on the display unit.

### Supplementary Note 10

The information processing device according to any one of Supplementary Notes 1 to 9,

wherein the display control unit is configured to display the second maintenance information including the list information of the first maintenance information corresponding to a predetermined number of the first detection data in descending order of a degree of similarity to the second detection data.

### Supplementary Note 11

The information processing device according to any one of Supplementary Notes 1 to 10,
wherein,
if there is any first detection data, among a predetermined number of the first detection data in descending order of a degree of similarity to the second detection data, indicating that a deterioration degree of the maintenance target equipment according to the corresponding first maintenance information is higher than a predetermined degree,
the display control unit is configured to display on the display unit attention information regarding a necessity of the maintenance.

### Supplementary Note 12

The information processing device according to any one of Supplementary Notes 1 to 11,
wherein the first detection data is first feature data indicative of feature values, in segment units, of time series data of one or more physical quantities indicating the past state of the maintenance target device, and
wherein the second detection data is second feature data indicative of feature values, in segment units, of time series data of one or more physical quantities indicating the current state of the maintenance target device.

### Supplementary Note 13

The information processing device according to Supplementary Note 12, further comprising

a feature extraction unit configured to generate the second feature data from the time series data of one or more physical quantities indicating the current state of the maintenance target device based on a feature converter that was used to generate the first feature data.

### Supplementary Note 14

A control method performed by an information processing device, the control method comprising:
matching
   a database,
which associates first detection data indicative of a past state of maintenance target equipment with first maintenance information relating to maintenance of the maintenance target equipment in the past state,
with second detection data indicative of a current state of the maintenance target equipment; and
displaying, based on a result of the matching, second maintenance information relating to maintenance in accordance with the current state of the maintenance target equipment on a display unit.

### Supplementary Note 15

A storage medium storing a program executed by a computer, the program causing the computer to function as:
a matching unit configured to match
   a database,
which associates first detection data indicative of a past state of maintenance target equipment with first maintenance information relating to maintenance of the maintenance target equipment in the past state,
with second detection data indicative of a current state of the maintenance target equipment; and
a display control unit configured to display, based on a result of the matching, second maintenance information relating to maintenance in accordance with the current state of the maintenance target equipment on a display unit.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### Description of Reference Numerals

1, 1A Information processing device
2 Storage device
3 Maintenance
4, 4A Display Device
5 State detection sensor
6 Past data generation device
20 Feature converter parameter information
21 Past data DB
21A Data base
22 Maintenance estimate history DB
24 Past detection signal DB
25 Maintenance history DB
100, 100A Preventive maintenance support system

What is claimed is:

1. An information processing device comprising:
at least one memory configured to store instructions: and
at least one processor configured to execute the instructions to
match a database,
which associates first detection data indicative of a past state of maintenance target equipment with first maintenance information relating to maintenance of the maintenance target equipment in the past state,
with second detection data indicative of a current state of the maintenance target equipment; and
display, based on a result of the matching, second maintenance information relating to maintenance in accordance with the current state of the maintenance target equipment on a display unit.

2. The information processing device according to claim 1,
wherein the first maintenance information includes information relating to a deterioration status of the maintenance target device in the past state, and
wherein the at least one processor is configured to execute the instructions to display the second maintenance information including the information relating to the deterioration status of the maintenance target device in the current state on the display unit.

3. The information processing device according to claim 2,
wherein the information relating to the deterioration status is information indicating at least one of
the number of elapsed days from last maintenance,
actual operation time of the maintenance target device from the last maintenance,
the number of operations of the maintenance target device from the last maintenance, or
a deterioration degree of the maintenance target device.

4. The information processing device according to claim 1,
wherein the at least one processor is configured to execute the instructions to output, as the result of the matching, the first maintenance information corresponding to a predetermined number of the first detection data in descending order of a degree of similarity to the second detection data, and
wherein the at least one processor is configured to execute the instructions to generate the second maintenance information based on the first maintenance information outputted as the result of the matching.

5. The information processing device according to claim 4,
wherein the at least one processor is configured to execute the instructions to generate the second maintenance information by weighting the first maintenance information based on
the degree of the similarity or
a ranking based on the degree of the similarity.

6. The information processing device according to claim 1,
wherein the at least one processor is configured to execute the instructions to display the second maintenance information including information indicating a timing of a next maintenance of the maintenance target device on the display unit.

7. The information processing device according to claim 6,
wherein the at least one processor is configured to execute the instructions to display on the display unit, as the information indicating the timing, information indicating at least one of
the number of remaining days before the next maintenance,
actual operation time of the maintenance target device before the next maintenance, or
the number of operations of the maintenance target device before the next maintenance.

8. The information processing device according to claim 6,
wherein the at least one processor is configured to execute the instructions to determine the timing based on the second maintenance information generated for a predetermined number of times in the past.

9. The information processing device according to claim 1,
wherein the at least one processor is configured to execute the instructions to display the second maintenance information for each type of the maintenance target device on the display unit.

10. The information processing device according to claim 1,
wherein the at least one processor is configured to execute the instructions to display the second maintenance information including the list information of the first maintenance information corresponding to a predetermined number of the first detection data in descending order of a degree of similarity to the second detection data.

11. The information processing device according to claim 1,
wherein,
if there is any first detection data, among a predetermined number of the first detection data in descending order of a degree of similarity to the second detection data, indicating that a deterioration degree of the maintenance target equipment according to the corresponding first maintenance information is higher than a predetermined degree,
the at least one processor is configured to execute the instructions to display on the display unit attention information regarding a necessity of the maintenance.

12. The information processing device according to claim 1,
wherein the first detection data is first feature data indicative of feature values, in segment units, of time series data of one or more physical quantities indicating the past state of the maintenance target device, and
wherein the second detection data is second feature data indicative of feature values, in segment units, of time series data of one or more physical quantities indicating the current state of the maintenance target device.

13. The information processing device according to claim 12,
wherein the at least one processor is further configured to execute the instructions to generate the second feature data from the time series data of one or more physical quantities indicating the current state of the maintenance target device based on a feature converter that was used to generate the first feature data.

14. A control method performed by an information processing device, the control method comprising:
matching a database,
which associates first detection data indicative of a past state of maintenance target equipment with first maintenance information relating to maintenance of the maintenance target equipment in the past state,
with second detection data indicative of a current state of the maintenance target equipment; and
displaying, based on a result of the matching, second maintenance information relating to maintenance in accordance with the current state of the maintenance target equipment on a display unit.

15. A non-transitory computer readable storage medium storing a program executed by a computer, the program causing the computer to: match
a database, which associates first detection data indicative of a past state of maintenance target equipment with first maintenance information relating to maintenance of the maintenance target equipment in the past state,
with second detection data indicative of a current state of the maintenance target equipment; and
display, based on a result of the matching, second maintenance information relating to maintenance in accordance with the current state of the maintenance target equipment on a display unit.
